(19) United States
(12) Patent Application Publication
(10) Pub. No.: US 2009/0144095 A1
(43) Pub. Date: Jun. 4, 2009

(54) METHOD AND SYSTEM FOR ASSESSING AND MANAGING BIOSAFETY AND BIOSECURITY RISKS

(76) Inventors: Gurinder S. Shahi, Montrose, CA (US); Arman H. Nadershahi, Los Angeles, CA (US)

Correspondence Address: Arman H. Nadershahi, Esq., 19614 Shadow Ridge Way, Northridge, CA, 91326, US

(21) Appl. No.: 12/038,643

(22) Filed: Feb. 27, 2008

Related U.S. Application Data
(60) Provisional application No. 60/891,975, filed on Feb. 28, 2007.

(51) Int. Cl. G06Q 40/00; G06Q 10/00; G06F 19/00

(52) U.S. Cl. 705/4; 705/7; 700/92

(57) ABSTRACT

Methods and systems for evaluating, mitigating, and managing biosafety and biosecurity risks. The methods and systems establish biosafety and biosecurity risk management procedures and systems, and facilitate auditing of facilities and testing individuals and companies to evaluate compliance with such procedures and systems. Systems and business methods for establishing biosafety and biosecurity risk management procedures and systems, auditing and certifying companies, facilities, systems and individuals for compliance, and analyzing biosafety and biosecurity risks for making investment decisions and for pricing and underwriting such risks in the insurance industry.

### CROSS REFERENCE TO RELATED APPLICATIONS

This patent application the claims the benefit of the filing date of U.S. provisional application Ser. No. 60/891,975, filed Feb. 28, 2007, entitled “Method and System for Evaluating and Managing Biosafety and Biosecurity Risks” the contents of which are incorporated herein by reference.

### BACKGROUND

1. Field

This application relates generally to methods and systems for evaluating, mitigating, and managing biosafety and biosecurity risks, and particularly relates to methods and systems for establishing biosafety and biosecurity risk management procedures and systems, and auditing facilities and testing individuals and companies to evaluate compliance with such procedures and systems. The application also relates to systems and business methods for establishing biosafety and biosecurity risk management procedures and systems, training and consulting, auditing and certifying companies, facilities, systems and individuals for compliance, and analyzing biosafety and biosecurity risks for minimizing the likelihood of accidental, natural or purposeful release of potentially hazardous materials and information, making investment decisions and for pricing and underwriting risk in the insurance industry, and preventing the unintended release or theft of commercially sensitive information that relate to proprietary products, services or technologies.

2. General Background

With the international proliferation of biological research in private sectors, academic institutions, governments, and other laboratories, biosafety and biosecurity risks have increased. Typically, “biosafety” refers to the containment principles, technologies and practices that are implemented to prevent unintentional exposure to pathogens and toxins, or their accidental release (or introduction, for that matter), and “biosecurity” refers to institutional and personal security measures designed to prevent the loss, theft, misuse, diversion or intentional release of pathogens or toxins. The intentional or accidental release of biological or other biohazardous materials could critically impact the health of large populations and global economies. Biosecurity risk may also be posed by epidemics and pandemics—in humans, in animal populations as well as in commercially and culturally important agricultural products. Such incidents could pose serious threats to national security, given the relative ease with which biological material and information can be copied, transported, used for quick and inexpensive manufacturing, and spread.

Currently, a lack of standardized procedures and management systems for the identification, management, and mitigation of biosafety and biosecurity risks increases the probability of such harmful incidents occurring. In addition, the absence of unified best practices, procedures and systems may complicate efforts of businesses and insurance providers to analyze such risks in the process of making investments, underwriting risk, providing insurance coverage, and other related business operations.

### SUMMARY

This application presents methods and systems for evaluating, mitigating, and managing biosafety and biosecurity risks. This application also presents methods and systems for establishing biosafety and biosecurity risk management procedures and systems and auditing facilities and testing individuals and companies to evaluate compliance with such procedures and systems. The application also relates to systems and business methods for establishing biosafety and biosecurity risk management procedures and systems, auditing and certifying companies, facilities, systems and individuals for compliance, and analyzing biosafety and biosecurity risks for making investment decisions and for pricing and underwriting risk in the insurance industry. It may also be applied to enabling ready identification of laboratories and facilities that operate in accordance with best practice principles and may be applied as a basis for determining if a particular lab or institution is suitable as a collaborator or is eligible to receive grant and other funding support. The methods and systems may be applied in numerous fields and applications where biosafety and biosecurity may present risks, including but not limited to: agriculture; bioremediation; health care; waste management; aquatic and marine environments; forestry; space and aeronautics; bio-industrial materials; synthetic biology; produce and poultry industries; nanotechnology; shipping and transportation; medical device, pharmaceutical, and biotechnology industries; defense and chemical and bioweapons; terrorism prevention; and basic research.

It is understood that other embodiments of the methods and systems will become readily apparent to those skilled in the art from the following detailed description, wherein it is shown and described only exemplary embodiments of the methods and systems by way of illustration. As will be realized, the methods and systems are capable of other and different embodiments and its several details are capable of modification in various other respects, all without departing from the spirit and scope of the invention. Accordingly, the drawings and detailed description are to be regarded as illustrative in nature and not as restrictive.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of the procedures of an exemplary embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION

The detailed description set forth below is intended as a description of exemplary embodiments and is not intended to represent the only embodiments in which the biosafety and biosecurity methods and systems can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the biosafety and biosecurity methods and systems. However, it will be apparent to those skilled in the art that the methods and systems may be practiced without these specific details.

The biosafety and biosecurity methods and systems include interrelated standards, processes, programs, and systems for identifying, preventing, and managing accidental and intentional harm arising out of activities involving biological materials. In particular, the methods and systems may include a coordinated program to establish standards and procedures (such as Good Biosecurity/Biosafety Practices, or GBP™), against which compliance may be monitored. An accreditation program may be developed whereby organizations and individuals may obtain certification based on several parameters, including but not limited to education, training, professional experience, and/or testing to determine competency, compliance, and understanding of the established biosafety and biosecurity standards, procedures, systems, and/or programs. Furthermore, first, second, and third party audits of biosafety and biosecurity organizational programs may be performed in order to obtain certification, improve biosecurity and biosafety, prevent accidental or intentional harm related to biological materials, and for other related benefits. The results of such audits and/or certification may be used as the basis for the awarding of various grants; investment by financial institutions, shareholders, and investment groups; and evaluation of risk for determining prices and for facilitating underwriting, sale, payment, and/or transfer of insurance policies by insurance companies. The present systems and methods may be implemented in various information technology (IT) systems to facilitate user compliance with GBP standards, laws, and guidelines. The IT tools may include databases, interactive guides, checklists, networks, communication tools, virtual environments, monitoring systems, and integrated safety and security systems to ensure and monitor compliance at various facilities and organizations.

Some of the risks related to biosecurity and biosafety include, but are not limited to accidental release of potentially hazardous materials, such as genetically modified organisms; mutagenic, toxic or noxious chemicals; viral or bacterial pathogens; and prions or genetic materials. The accidental release may lead to contamination of food sources and food chains. Risks may be caused by accidental leakage or spills, and accidental breaches of biosecurity systems. Biosecurity and biosafety risks may also include natural exposures, such as epidemics and pandemics, including those affecting humans, animal populations, and plants. Risks may also include intentional harm, such as bioterrorism, extortion, industrial espionage, and other purposeful actions. The need to ensure Good BioSecurity/BioSafety Practice has become increasingly important in the wake of growing concern regarding the possibility of accidental, terrorist, state-sponsored or even private corporate misuse of life science technology. The methods and systems may be applied in numerous fields and applications where biosafety and biosecurity may present risks, including but not limited to: agriculture; bioremediation; health care; waste management; aquatic and marine environments; forestry; space and aeronautics; bio-industrial materials; synthetic biology; produce and poultry industries; nanotechnology; shipping and transportation; medical device, pharmaceutical, and biotechnology industries; defense and chemical and bioweapons; terrorism prevention; and basic research.

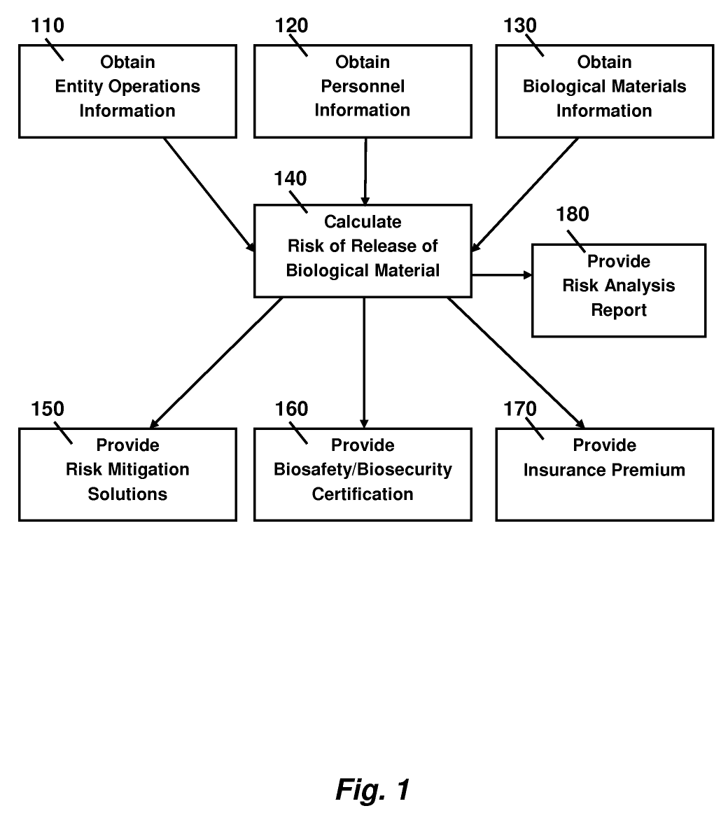

FIG. 1 shows an exemplary embodiment of a biosecurity and biosafety system. The exemplary system may comprise any combination of input processes 110 (Entity Operations Information), 120 (Personnel Information), and 130 (Biological Materials Information). Furthermore, in some embodiments additional inputs may be utilized by the system. The input information may be obtained in various ways and in various formats as described in further detail below. For example, information may be obtained from internet website questionnaires, email surveys, paper surveys, in person audits, interviews, surveillance, data tracking, and other means and formats known to those skilled in the art. As described in further detail below, in process 110 information about the company and/or entity (such as a businesses, laboratories, farms, universities, institutions, and other organizations, including but not limited to public organizations, private organizations, and governmental organizations; the terms “company” and “entity” will be used interchangeably hereafter) may be obtained and used in process 140 to calculate the risk of release of biological material. The process of calculation 140 is described in further detail below. The type of release, which is also described in further detail below, may be for example, inadvertent, intentional, theft, escape, various forms of spreading, etc. The calculation of risk 140 may be based on the input 110 on its own or in combination with other inputs, including but not limited to 120 and 130. Process 120 of obtaining personnel information is described in further detail below, and in some embodiments may be obtained by similar means as those described for process 110. Personnel information 120 may be used alone or in conjunction with other inputs in calculating the risk of release in process 140. Process 130 of obtaining biological materials information is described in further detail below, and in some embodiments may be obtained by similar means as those described for process 110. Biological materials information 130 may be used alone or in conjunction with other inputs in calculating the risk of release in process 140. Furthermore, the material may include various types of material and/or information as described below.

The calculated risk of release of biological material 140 may be used in various ways, some of which are presented in the exemplary embodiment of FIG. 1. For example, in an exemplary embodiment the calculation of risk 140 may be used to provide a risk analysis report as in 180. The user report may be generated in various forms known to those skilled in the art, as for example, paper documents, electronic documents, email, web-based, etc. Raw data may be provided to the user in some embodiments, and in some embodiments reports may include analyses and interpretations of the results. The report from 180 may be used for many purposes, in addition to those described in further detail below.

In another exemplary embodiment, the system generates and provides risk mitigation solutions 150. The risk mitigation solutions may be based upon the calculated risk 140 alone or may consist of a combination of calculation 140 along with other factors both included and not included in FIG. 1. Some examples of risk mitigation solutions are described in further detail below.

In another exemplary embodiment, the system of FIG. 1 provides Biosafety/Biosecurity Certification 160. The certification 160 may be based upon the calculated risk 140 alone or may consist of a combination of calculation 140 along with other factors both included and not included in FIG. 1. Some examples of the certification process 160 is described in further detail below.

In another exemplary embodiment, the system of FIG. 1 provides an insurance premium 170. The insurance premium 170 may be based upon the calculated risk 140 alone or may consist of a combination of calculation 140 along with other factors both included and not included in FIG. 1. Some examples of the insurance premium process 170 is described in further detail below.

In other embodiments, various combinations of inputs 110, 120, and 130, and outputs 180, 150, 160 and 170 may be utilized. Some embodiments of the methods, systems and devices may also include inputs and/or outputs not shown in FIG. 1.

### An Exemplary International Good BioSecurity/BioSafety Practice Accreditation System.

Some exemplary operating elements of the International Good Biosecurity Practice (GBP™) Accreditation System include international good BioSecurity/BioSafety practice performance standards and guidelines, which include agreed performance and best practice standards together with appropriate guidelines to enable participating institutions, organizations and corporations to achieve GBP whereby the risk of accidental or purposeful exposure to biological hazards is minimized while biosafety, biosecurity and beneficial use of life science and biotechnology is maximized. Intrinsic in the performance standards and guidelines development process is the need for internationally acceptable codes of conduct at the individual and organization levels.

The accreditation system may also include an International Good BioSecurity/BioSafety Practice education and training program, which includes education and training resources for providing managerial and scientific/technical personnel with the necessary insights and understanding to operate facilities, equipment, practices and procedures in accordance with Good Biosecurity Practice. In addition to developing educational and training curricula, handbooks and manuals for Good Biosecurity Practice, the education and training program may also serve as the accreditation body responsible for accreditation of certified training instructors and approved training centers; and for administration of testing and continuing education assessments in International Good Biosecurity Practice.

The accreditation system may also include an International Good BioSecurity/BioSafety Practice Audit and accreditation program, to take responsibility for the conduct of formal performance audits of personnel and facilities seeking to achieve international GBP accreditation. The program may also take responsibility for the appointment of accredited audit inspectors who are accredited for assignment through the program to formally conduct international GBP audits, as appropriate.

International Good Biosecurity Practice performance standards and guidelines may take due account of such key areas of concern as international and national laws and regulations, which includes working to facilitate the development of effective national and international laws, regulations, and policies in relation to ensuring the achievement of International GBP.

The GBP standards and guidelines may also include provisions relating to personnel. For example, there may be a requirement for exercising the highest standards in the recruitment, training, and management of personnel during and after employment, with special attention to those individuals with access to information, materials, and technology that could have significant adverse effects on public health, safety, and security if misused or not employed safely and appropriately. As outlined above, institutions, corporations and organizations which seek to achieve Good Biosecurity/Biosafety Practice may have codes of conduct for employees at the individual as well as at the organizational levels.

The GBP standards and guidelines may also serve to ensure the security of information by observing relevant international and national laws and regulations in handling information which could have a significant negative impact on public health, safety, and security; and contributing to developing, in cooperation with governments, effective and responsible procedures for the release of such information into the public domain.

GBP Standards and Guidelines may also serve to ensure safe and secure operation of facilities and equipment. Specifically, GBPs may function to achieve high standards for the safe and secure operation of all facilities, including materials in transit, and proper handling of wastes, in the interest of public health and environmental safety; and contributing to the development of more effective international and national laws, regulations, guidelines, policies, and standards in this regard.

GBPs may also encompass the governance of research and development activities, which includes taking account of public health, safety, and security considerations when planning and conducting research and development activities; and supporting and contributing to effective and responsible international and national entities engaged in developing and promoting codes of conduct in this regard.

The GBP standards and guidelines may also include activities, discussed in much further detail below, related to Risk Evaluation and Mitigation, which includes facilitating the development of measures to evaluate and mitigate the risks arising from the misuse the life sciences and cooperate to support an international response in cases of major natural (and man-made) biological outbreaks.

Furthermore, the accreditation system may include systems and methods for rating Good BioSecurity/BioSafety capabilities and performance in various contexts, including but not limited to ratings for individuals; facilities, institutions, organizations and corporations; and for states and national Biosecurity and Biosafety readiness.

The guidelines, standards, and accreditation system may include numerous proficiency levels for various individuals. For example, there may be GBP for Life Science Professionals™ (including managers, administrators, scientists and technical staff who work, or intend to work, with life science institutions, organizations and corporations)—which may, in effect, be the entry level of proficiency in GBP. This level of proficiency may be obtained after undergoing both a theory-focused knowledge training component and a practice-focused practical training component, and successful completion of education and training program administered tests (the knowledge test and the practical test) in each component.

The knowledge training component may be via a state-of-the-art online self-directed multimedia training course developed and run by the education and training program, and that the practical training component is conducted as multi-day practical training workshops run by education and training program-approved certified training instructors (see below). Individuals may only be allowed to take the education and training program administered knowledge and practical tests after successfully completing each training course respectively. They would receive certification as having completed the requirements for International GBP for Life Science Professionals™ after passing both tests.

Also, to ensure currency of knowledge and understanding, there may be a continuing education requirement such that individuals may be required to undergo an approved training course and successfully complete the knowledge and practical tests once every twenty-four months to maintain currency.

The GBP standards and accreditation system may also include Good BioSecurity/BioSafety Practice (GBP) for Certified Training Instructors™. This level of proficiency may be required for any individual who wishes to conduct training programs in GBP. For example, individuals who have successfully completed the entry level proficiency program may move on to undertake the training program for certified training instructors and subsequently take the knowledge and practical tests for certified training instructors. Certified training instructors may also be required to complete continuing education programs and to successfully complete the knowledge and practical tests for certified training instructors at least once every 18 months to maintain currency.

The GBP standards and accreditation system may also include Good BioSecurity/BioSafety Practice (GBP) for Accredited Audit Inspectors™. This level of proficiency may be required for any individual who wishes to go beyond conducting training courses to actually be approved to conduct performance audits on assignment by the audit and accreditation program, and to provide consulting and advisory services to institutions, organizations and corporations seeking to ensure that their personnel, facilities, practices and procedures conform to GBP requirements. Individuals who have successfully achieved GBP Certified Training Instructor™ level may move on to undertake the training program for accredited audit inspectors and subsequently take the knowledge and practical tests for accredited audit inspectors. Audit inspectors may also be required to complete continuing education programs and to successfully complete the knowledge and practical tests for accredited audit inspectors at least once every 12 months to maintain currency.

Good BioSecurity/BioSafety Practice (GBP) accreditation may also be applied to facilities. For example, since an institution, organization or corporation may likely have several functional units or facilities (such as R&D laboratories, manufacturing facilities, clinical and field experimental sites, farms, zoos, processing and manufacturing facilities for food, plant and animal products, locations where biological material is handled, stored, marketed or disposed off including but not limited to refrigeration facilities, supermarkets and groceries, incineration plants, mortuaries, cemeteries, nuclear plants, sometimes spread over several different physical locations and even in different states or continents—herein collectively termed “companies”). GBP may be implemented in at least two levels of the organization. First, GBP may include Facility Good BioSecurity/BioSafety Practice Certification™ (FGBP™), which may be focused on individual sub-unit laboratories or facilities where relevant research, development, manufacturing, testing or use of potentially sensitive or hazardous material takes place. In such assessments, elements to be evaluated may include personnel, equipment, facility design, practices and procedures, etc, would be evaluated. Examples of details of appropriate performance and practice standards for GBP facility proficiency are described in further detail below.

Another level of GBP for organizations includes Organizational Good BioSecurity/BioSafety Practice Certification™ (OGBP™), which may entail assessment at the whole organizational level, incorporating consideration of governance, management and operation of administrative units as well as of the laboratories and facilities belonging to the organization, and their interactions as a whole. Examples of details of appropriate performance and practice standards for GBP organizational proficiency are described in further detail below.

An additional level of GBP includes state and national Good BioSecurity/BioSafety Practice. For example such a program may state and national commitment to GBP through, for example, requiring minimum proficiency levels for Life Science Professionals; adoption of appropriate international conventions, national legislation and requirement for performance standards consistent with International GBP; and establishment of state or national Biosecurity and Biosafety coordinating agencies. Assessment and monitoring at this level could involve a combination of self-declaration by relevant authorities in each state/nation, assessment by the education and training program, details of appropriate performance and practice standards are to be developed.

Establishment of a GBP accreditation system may require interaction of various components. For example, first, international Good BioSecurity/BioSafety practice performance standards and guidelines could be established. An international advisory committee for the international GBP accreditation system could be established and consist of leading experts and authorities on biosafety and biosecurity as well as representatives of key partner agencies and organizations (such as the International Red Cross, WHO, and leading national agencies). An international advisory committee may be established to guide, review, suggest revisions, and approve GBP performance standards and guidelines drafted by a Secretariat for the International Good BioSecurity/BioSafety Practice Accreditation System. Finally, GBP performance standards and guidelines could be formally released by the International Advisory Committee.

After establishing the guidelines and standards, an International Good BioSecurity/BioSafety practice education and training program could be established. This may include development of educational and training curricula, training handbooks and manuals, educational resources, and question bank for testing and evaluation to be developed and maintained by education and training program. Furthermore, accreditation and maintenance of a roster of certified training instructors and approved training and testing centers could be undertaken. Finally, the program could include centralized administration of GBP examinations applying computer-based testing technology.

Finally, a Good BioSecurity/BioSafety Practice audit and accreditation program may be established. Such a program could include accreditation and maintenance of a roster of accredited audit inspectors, and maintenance of database of specific facilities as well as institutions, organizations and corporations that have Good BioSecurity/BioSafety Practice.

Some or all of the data relating to the standards, audits, compliance, certification, may be stored in a database. In some embodiments, the database may be available online, and in some cases very highly protected by security means (such as digital encryption, for example) known to those skilled in the art. The information may be accessible for various biosafety and biosecurity uses, including but not limited to monitoring; providing or restricting access of certain individuals, organizations, or facilities to hazardous materials; providing information to financial institutions; insurers; or other business entities; and providing or restricting access to information to various states and other governmental entities.

### Exemplary Method and System of Auditing and Assessing Biosecurity and Biosafety Compliance and Risk.

The present invention involves a system and method for producing a quantitative and precise assessment of overall risk of accidental or intentional release or theft of biological information or materials. This system and method for assessing biological threats to a company and/or entity (such as a businesses, laboratories, farms, universities, institutions, and other organizations, including but not limited to public organizations, private organizations, and governmental organizations; the terms “company” and “entity” will be used interchangeably hereafter) involves several steps. One step involves obtaining audit information relating to the company, particularly information relating to the company's biosecurity systems and practices. Another step involves obtaining information about company personnel. Also, information about the biological, chemical, and physical nature of the biological materials or information, and its handling and procedures, may be obtained. Finally, the audit, personnel, and biological information is combined and scored to determine a risk index of the risk to the business of harmful release of biological materials. A machine-readable program storage device stores encoded instructions for normalizing a company's risk assessment and calculating, evaluating, analyzing and conducting sub-analysis on a company's and the industry's relative degree of risk and compliance with Good Biosecurity Practices.

The risk index may seek to identify a variety of surrogate markers designed, on average, to accurately estimate the degree of risk and compliance for a company/entity. Each category is explained in further detail in the exemplary embodiments below.

Audits of Company/Entity Operations, Practices, Facilities.

First, an audit of the company's biosafety and biosecurity practices, systems, and/or facilities may be conducted. The audit may take several forms, including but not limited to: online and/or written questionnaires, in-person third party audits, and internal audits. A threat analysis, the first step in determining risk, identifies and evaluates each threat on the basis of different factors (e.g., the capability and intent to attack an asset, the likelihood of a successful attack, and the attack's probable lethality). Risk management is the deliberate process of understanding risk (i.e., the likelihood that a threat will harm an asset with certain severity of consequences) and deciding on and implementing actions to reduce that risk. Risk management principles may be based on the premises that 1) although risk usually cannot be eliminated, it can be reduced by enhancing protection from validated and credible threats; 2) although threats are possible, certain threats are more probable than others; and 3) all assets are not equally critical. The risk assessment may include a systematic approach in which threats are defined and vulnerabilities are examined; risks associated with those vulnerabilities are mitigated with a security systems approach. The audit may examine whether a security plan exists that includes collaboration between senior management, scientific staff, human resource officials, information technology (IT) staff, engineering officials, and security officials.

Next, a facility security plan may be audited. The audit may determine whether: the company has developed a comprehensive security plan that complies with GBPs and reviews the need for policies in physical security; data and IT system security; security policies for personnel; policies for accessing select agent areas; specimen accountability; receipt of select agents into the laboratory; transfer or shipping of select agents from the laboratory; emergency response plans; and reporting of incidents, injuries, and breaches. Biosecurity and biosafety policies may be based on site-specific assessments. The audit may determine whether: security and safety plans include measures that address physical security of building and laboratory areas; policies should also address concerns associated with access, use, storage, and transfer of sensitive data; IT specialists assess the security of hardware and software products in addition to the security of local area networks; IT tracking of system access and changes; procedures should be reviewed after any incident or change in regulations; necessary changes are incorporated into the revised plans and communicated to all; laboratory supervisors ensure that all laboratory workers and visitors understand security requirements and that all employees are trained and equipped to follow established procedures; new employees receive training when they first begin work, and all employees receive regular training thereafter; training is updated as policies and procedures change; training is documented by maintaining records of training schedules and employee attendance; and security plans receive periodic performance testing to determine their effectiveness.

The audit may also be conducted to determine whether: access is controlled to areas where select agents and biomaterials are used or stored; laboratory work areas are consolidated to the greatest extent possible to implement security measures more effectively; select agent areas are separated from the public areas of the buildings; all select agent areas are locked when unoccupied; use keys or other security devices permit entry into secure areas; methods of secure access and monitoring controls include key or electronic locking pass keys, combination key pad, use of lock-boxes to store materials in freezers or refrigerators, video surveillance cameras, or other control requirements; protocols for periodically changing combination keypad access numbers should are developed; the need for graded levels of security protection on the basis of site-specific risk and threat analysis are assessed; security is accomplished through card access systems, biometrics, or other systems that provide restricted access; all freezers, refrigerators, cabinets, and other containers where select agents are stored are locked when they are not in direct view of a laboratory worker; access is limited to select agent areas to authorized personnel who have been cleared by the US Department of Justice as indicated in 42 CFR Part 73; all others entering select agent areas are escorted and monitored by authorized personnel; all entries into these areas, including entries by visitors, maintenance workers, service workers, and others needing one-time or occasional entry are recorded; routine cleaning, maintenance, and repairs are limited to hours when authorized employees are present and able to serve as escorts and monitors; procedures and training are established for admitting repair personnel or other contractors who require repetitive or emergency access to select agent areas; visitors are issued identification badges, including name and expiration date, and escorted and monitored into and out of select agent areas, and such visits should be kept to a minimum; procedures are in place for reporting and removing unauthorized persons, and are developed through collaboration among senior scientific, administrative, and security management personnel; security procedures are included in security training and reviewed for compliance at least annually.

The audit may also be used to ascertain whether: an emergency response plan has been incorporated and audited for GBP; laboratory emergency plans have been integrated with facility-wide plans; plans also include such adverse event assessments as bomb threats, severe weather (e.g., hurricanes or floods), earthquakes, power outages, and other natural or man-made disasters; facility administrators, scientific directors, principal investigators, laboratory workers, maintenance and engineering support staff, facility safety officers, and facility security officials have been included in emergency planning; provisions for immediate notification of and response by laboratory and animal directors, laboratory workers, safety office personnel, or other knowledgeable persons are included for when an emergency occurs; advance coordination occurs with local police, fire, and other emergency responders to assist community emergency responders in planning for emergencies in select agent laboratory and animal areas; plans address security concerns associated with sharing of sensitive information regarding secure work areas; the plan covers circumstances that might require the emergency relocation of select agents to another secure location; and that employees are trained and exercises of the emergency response plan are conducted at least annually.

Audits may also be used to assess whether the company: has protocols for reporting adverse incidents; ensures that laboratory directors, in cooperation with facility safety, security, and public relations officials, have policies and procedures in place for reporting and investigating unintentional injuries, incidents (e.g., unauthorized personnel in restricted areas, missing biologic agents or toxins, and unusual or threatening phone calls), or breaches in security measures; notifies regulatory agencies and authorized bodies immediately if select agents are discovered to be missing, released outside the laboratory, involved in worker exposures or infections, or misused; reports all incidents involving select agents (e.g., occupational exposure or breaches of primary containment) to local and state public health authorities.

These audits might also cover such areas as design controls, clinical trials, corrective and preventive actions, complaints, incident reporting and management controls in appropriate industries. Additionally, the observations that come out of these audits can be grouped into “major observations” and “minor observations.” The index calculation may examine and categorize the observations as major or minor, and the total of the auditing observations may be calculated based on weighted averages that reflect the relative importance of the audit subject.

With regard to the collection of the audit data, one of the features of the index that is designed to facilitate efficient collection and meaningful evaluation of data is a standardized audit report form for internal audits. In some embodiments, the audit report form and audit checklists/questionnaires may be modular and customizable for various types of companies.

To eliminate this inconsistency and to allow aggregation and benchmarking of data, the index may incorporate a template for audit reports. The template seeks to incorporate all of the best auditing practices, or generally accepted GBP compliance principles, while at the same time remaining practical for widespread use. The design of the template allows meaningful aggregation of the data collected. The draft template may be accompanied by guidance on the definitions of critical, major, and minor observations, as well as a system of enhanced observation codes. A further enhancement for data entry, processing, and feedback is an optional, an online service that permits auditors to complete their reports using a secure web site. This online capability offers some important features. First, it makes the use of the observation codes easier because it allows the user to search for terms in the code descriptions, pull up the potential codes and simply drop the right one in rather than retype it. The narrative portion of the report can be filled out with easy access to the accompanying guidance on observations. The potential for incomplete data reporting is reduced by programming the server to require completion of all mandatory fields before accepting an audit report. When complete, the auditor can e-mail the completed report to whoever needs a copy and print out hard copies as necessary. To facilitate acceptance among the community of users the on-line audit template may be designed to be compatible, with many leading audit management information technology systems. Consequently the compatibility enables a user to import information from the GBP template into its own audit management software or export information contained in its audit management software into the template.

Selected fields of data may be compiled in organization-specific and industry databases for use in benchmarking. The quality of the audit may be evaluated by trained consultants who read the report and grade its quality (that is, the quality of the written report and by implication the quality of the underlying audit) according to established criteria. If the audit report quality grades awarded by the two different consultants differ by more than a selected value, the audit report will be delivered to a third auditor for resolution of the variance. When the grading process is complete, the system may notify for example by e-mail, a pre-designated individual any time an audit report receives a failing grade. The data entered into the industry database may be proportionately discounted if it comes from a report that receives less than a satisfactory grade.

Many benefits could inure to companies who use the audit template. The first is compliance management. The compiled database for the audited enterprise and the industry data base can be available to an enterprise for use in their daily compliance management and benchmarking of improvements. The entity specific databases and industry databases may be used by an entity to identify (a) trends across the audited entity in terms of observations, and (b) areas of the entity—geographic as well as quality subsystems—that could benefit from further evaluation. A second key benefit is that the database may allow automatic comparison of the audit results in three ways: intra-entity; inter-entity using the industry database; and with the data obtained from inspections. A further benefit is the rapid update of an entity's overall index score. Rapid update enables entities to effectively monitor their compliance levels over time, if desired, even daily. The pervasive use of these audit report templates should enhance the quality of the underlying audits. Also, having an objective process for assessing the quality of audit reports gives the entities employing the auditors a basis for identifying which auditors need further training.

With regard to the method of calculation, prior company audit data may be accorded a significant percentage of the overall index; for example, thirty five percent (35%) may be a fair portion. Prior audits may receive the most weight because the best source of compliance data is the company's own organized assessments. Although this may vary depending on quality, scope and number, audit data will typically be broad in scope and one of the most reliable barometers of a company's compliance. Other variables may be combined with such prior auditing to better assess the scope, quantity and quality of the audits. For example, what audits has the company or its consultants conducted over the last three years?

With answers to those questions, the method then assigns relative weights to the auditing areas. When compiling the data for company audits, these various elements should be accumulated for each business unit or entity (as appropriate). For any areas not audited within the last year, the score may be as little as zero depending on the nature of the industry and the importance of that element to the business being evaluated. For all audits conducted, their quality, scope and outcome will be assessed and scored. For example, the quality and scope of the auditing may be rated by a factor of 0 to 1, in 0.1 increments (This is a unitary measurement, not a midline measurement. In other words, the average is not 0.5. Audits should be evaluated in terms of both scope and quality, and if adequate in both areas the audit may receive a score of 1). The outcome of the audit may also be rated between 0 and 1 to reflect the overall degree of compliance found, following the following guidelines (this also is not a midline score): Subtract 0.1 for each major observation; subtract 0.02 for each minor observation. The score for each audited area may be calculated by multiplying the percentage weight for the particular audit area, the quality and scope score for the audit, and the outcome score for the audit. A business unit's audit score is equal to the sum of all audit scores for each audit area.

A similar analysis may be made on a company or corporate level (although there is not an explicit regulatory requirement for “corporate” auditing, most companies impose some form of corporate auditing requirement on the company). Corporate audits of business units should have a substantial portion of this element, for example about fifty percent (50%). Another major element of the corporate level audit, allocated for example about thirty percent (30%), relates to management review and/or trending (an audit of corporate functions of management). Finally, with regard to operations within a company, another element, allocated for example twenty percent (20%) involves a corporate audit of the CAPA (corrective and preventative action) function. The corporate audits of business units are scored the same way audits of business units are scored; however, the components of the scoring of management reviews/trending and CAPA audits are treated as “binary” scores. That is, companies that conduct these audits will receive a higher corporate audit score, but companies that do not conduct these types of audits will not be penalized.

For the total audit sub-score, an average of the scores for each business unit is calculated, and corporate is weighted as about twenty-five percent (25%) (Corporate has the broadest perspective with regard to the entire company's compliance, and the effectiveness of corporate functions is a major determinate for compliance by the rest of the company, hence the significance of the weight). This score may be converted to a quartile scale.

Company Personnel and Policies.

Security and safety-related information may be obtained and audited for all personnel. Audits, background searches, interviews, and questionnaires may be used to determine whether: the company has honest, reliable, and conscientious workers; facility administrators and laboratory directors are familiar with all laboratory workers; a policy exists for screening employees who require access to select agent areas to include full- and part-time employees, contractors, emergency personnel, and visitors; and additional screening exists for employees who require access to other types of sensitive or secure data and work areas. These screening procedures may be commensurate with the sensitivity of the data and work areas (e.g., federal security clearances for government employees and contractors). The system and method may also determine whether workers approved for access to select agents (e.g., students, research scientists, and other short-term employees) wear visible identification badges that include, at a minimum, a photograph, the wearer's name, and an expiration date.

To capture other data, as well as softer issues like the company's incorporation of best practices in the compliance area and the company's overall compliance culture, the index may utilize a survey of individuals within the company who have compliance responsibilities. The survey may take two forms. First, there may be a written questionnaire that addresses known or suspected noncompliance shortcomings, adoption of best practices, compliance culture and the status of the company's relationship with the regulatory organization. The questions are combined on the basis of relative weights. Second, there is an oral interview with those who responded to the written questionnaire in order to drill down more deeply into the issues raised by the questionnaire.

Company compliance interviews may provide a significant portion of the evaluated data, for example about twenty-five percent (25%) of the index value (While auditing focuses on compliance with specific requirements of the quality system regulations, there is much more to compliance. For example, auditing may not evaluate many best practices, as well as softer types of information such as the company's relationship with the regulatory organization and company culture. Moreover, there are likely to be whole segments of the company that the company does not audit, but which managers know present compliance challenges, such as data integrity and marketing claims). To obtain reliable data for this component, statistical sampling techniques may be used. For example, the number of interviewees should typically be at least three and should reflect a balance between regulatory and quality compliance. The interviews may include all compliance personnel, or at least one from each division within the company, as well as from corporate regulatory and quality. The subject of the written questionnaire and oral interview should include (with exemplary percentages): Known or suspected compliance shortcomings (50%) (Known and suspected compliance shortcomings receive the highest weight because this factor bears directly on risk of enforcement); Adoption of best practices (20%) (Best practices receive the second highest weight, because aside from knowledge of a specific compliance issue, our experience has shown that the strength of the best practice adoption is a key indicator of compliance. For example, the Federal Sentencing Guidelines that apply to convicted organizational defendants provide that part of a sentencing court's consideration is whether an organization had an “effective program to prevent and detect violations of law,” which means a program that is reasonably designed, implemented, and enforced so that it generally is effective in preventing and detecting criminal conduct); Compliance culture (20%) (Although a company's culture is not easily measured, this factor is nevertheless a crucial determinant of whether a company's employees will work toward compliance); and Relationship with the regulatory organization (10%) (This receives the lowest weight because, although an important risk factor, it is less important than actually achieving compliance. Nonetheless, most companies have some area of noncompliance, and their relationship with the regulatory organization may well determine whether the organization challenges them).

The written questionnaire may include the statements to be assessed and answered by the respondent on a scale of that corresponds to numerical data points ranging from 1 to 7, which, for the respondent, corresponds to a range of written descriptions: Strongly Agree, Neutral/Don't Know, and Strongly Disagree. The following are examples of questions for a written questionnaire for the device operations of a regulated company:

Compliance Statements My company's compliance has improved from where it was 5 years ago. My company's compliance is better than other companies about the same size that make similar products. My company has areas where it needs to improve its compliance. My company's compliance needs to be improved significantly. My company has problems with compliance that it seems unable to resolve. My company's quality system covers biosecurity and biosafety risks. When my company sponsors a clinical trial or other research, it ships the product or material being investigated only to participating investigators. In research in which my company is the sponsor, it has obtained a signed agreement from each investigator participating in the study. My company conducts investigations on all unanticipated adverse events arising out of its research. My company terminates all research when an unanticipated adverse effect presents an unreasonable risk to humans, animals, or the environment. My company has a well-developed system for ensuring its compliance with record-keeping and reporting requirements relating to research it sponsors. My company always reports reportable events that occur in research that it sponsors. My company monitors all research that it sponsors to ensure compliance regulations. Overall, my company needs to improve its compliance with regulatory requirements relating to research and security. My company has registered all establishments as required under regulation. My company updates its registrations annually. My company notifies necessary regulatory agencies within 30 days of changes in ownership, corporate or partnership structure, or location of registered establishments. My company lists all products as required by regulation. My company updates its listing biannually or when a change occurs as required by regulation. My company maintains a file with copies of all labeling, advertisements and package inserts, as required by regulation. Executive management has established its policy, objectives for, and commitment to quality, safety, and security. Executive management ensures that policies are understood, implemented, and maintained at all levels of my company. Executive management reviews my company's GBP system with sufficient frequency to ensure that it satisfies applicable quality system regulations. My company has established a GBP plan that defines its quality practices, resources, and activities relevant to its products. My company has established GBP system procedures and instructions. My company has well-developed and effective auditing procedures and policies. My company uses audit findings effectively to address compliance issues. Audits are conducted by individuals who do not have direct responsibility for the matter being audited. A report of the result of each quality audit is always made and reviewed by management having responsibility for the matters audited. My company has sufficient quality control personnel to ensure compliance with quality system regulations. My company ensures that all quality control personnel have adequate training to perform their job responsibilities. My company documents all employee training. My company has a strong research control system. My company has a strong document control system. My company reviews, approves, communicates, and maintains a record on the changes to GBP control documents. My company has a strong purchasing control system. My company has procedures for identifying products during all stages of receipt, production, distribution, and installation. My company has strong production and process controls. My company integrates GBP controls into the production process. My company's GBP control procedures ensure that all measuring, inspection, and test equipment is maintained appropriately to ensure valid results. My company has a strong process validation system. My company has developed GBP control procedures for inspections, tests, and other verification of incoming product. My company has established procedures that address how nonconforming products should be handled, including how such product should be disposed. My company has a strong corrective and preventive action (“CAPA”) system. My company often prevents quality issues from arising. My company has a strong labeling and packaging control system. My company has strong procedures to ensure that its products are handled, stored, distributed and installed appropriately. My company maintains all GBP system records that are required under the quality system regulation. My company has written GBP procedures for internal systems and for documentation and recordkeeping requirements. My company has established and maintains GBP event files. Overall, my company needs to improve its compliance with post-market reporting obligations (e.g., adverse incident reporting). My company timely reports to regulatory actions concerning corrections and removal. My company maintains records of all corrections and removals not reported to regulatory agencies. Overall, my company needs to improve its compliance with regulatory requirements relating to corrections and removals. Where required, my company has a strong system for ensuring that its products are tracked as required by GBP regulations. My company has implemented a tracking program whenever it has been ordered to do so by regulatory agencies. My company has implemented post-market surveillance studies whenever it has been ordered to do so by regulatory agencies. Overall, my company needs to improve compliance with tracking and post-market surveillance requirements. My company has a strong system for ensuring that both internal and external documents are accurate (Several federal statutes criminalize the falsification of data ultimately given to the federal government). There are ramifications at my company for employees who falsify data. My company rewards employees who uphold data integrity standards. Overall, my company needs to improve compliance with laws regulating data integrity.

Best Practices Statements: (Many of these questions are derived from the Federal Sentencing Guidelines that apply to convicted defendants that are organizations. The Guidelines provide guidance and direction to federal sentencing courts when sentencing a convicted defendant. Part of a court's consideration is whether an organization had an “effective program to prevent and detect violations of law,” which means a program that is reasonably designed, implemented, and enforced so that it generally is effective in preventing and detecting criminal conduct. Additionally, “[t]he hallmark of an effective program to prevent and detect violations of law is that the organization exercised due diligence in seeking to prevent and detect criminal conduct by its employees and other agents.” Due diligence requires that the organization take seven steps in its program, and these seven steps are reflected in this and the following six categories.) My company's compliance program is effective in preventing and detecting criminal conduct by its employees (As part of an effective compliance program under the Federal Sentencing Guidelines, an organization must have established compliance standards and procedures to be followed by its employees and other agents, which are reasonably capable of reducing the prospect of criminal conduct). My company has identified the legal requirements applicable to its operations and has translated them into understandable criteria for lawful conduct. Current government enforcement policies, priorities and initiatives receive special emphasis in my company's compliance programs. My company reviews its own history and the histories of other similar companies to identify laws that have been violated and what laws prosecutors charged in those cases. My company has identified employees who, because of their responsibilities or duties, are more likely to have opportunities for committing compliance violations. My company's standards, procedures, and controls ensure that legal requirements are followed or, if they are not followed, that undesirable conduct is detected and reported. My company's compliance program is designed to detect compliance violations by agents authorized to act on behalf of my company. My company retains the right to audit independent contractors. My company contractually requires independent contractors to adhere to a compliance program. My company has a Code of Conduct that comprehensively addresses compliance rules, ethics, and values. Compliance policies have a multi-tiered approach focused toward the subsidiaries, divisions, and departments of my company. My company's corporate policies are well-known, well understood and always followed by the various divisions of the company. My company has designated high level personnel to be responsible for compliance (Pursuant to the Guidelines, as part of the program, the organization must have assigned specific individual(s) within high-level personnel of the organization overall responsibility to oversee compliance with the program's standards and procedures). My company's compliance program ensures that responsibility for its compliance program is in authoritative hands. When a team approach is used for compliance, direction is still ensured and necessary action is still implemented. My company has an officially designated compliance officer with responsibility for the compliance with the laws of GBP. The compliance officer is effective at his or her job. The compliance officer publicizes the elements of the compliance program such that the employees know and understand them. The Board of Directors has an audit or compliance committee. My company does not delegate substantial discretionary authority to employees known to have a propensity to engage in illegal activities (The Guidelines also specify that in developing a program, the organization must also have used due care not to delegate substantial discretionary authority to individuals whom the organization knew, or should have known, had a propensity to engage in illegal activities). My company has a rigorous screening process for compliance personnel at their initial hiring. My company has a sufficiently rigorous screening process for personnel as promotions to positions with increased responsibilities and discretionary authority occurs. In the human relations department, my company does a good job of screening employees to ensure that they are committed to achieving compliance objectives before they are hired. My company consistently reviews discretionary aspects of positions to determine whether existing checks and balances are adequate to safeguard against unwarranted discretionary authority. My company always conducts exit interviews for key compliance personnel. My company effectively communicates its standards and procedures to all employees and agents by requiring participation in training programs (The Guidelines contemplate that in order to have an effective compliance program, the organization must have taken steps to communicate its standards and procedures to be followed by its employees and other agents, for example, by requiring participation in training programs or by disseminating publications that explain in a practical manner what is required). My company effectively communicates its standards and procedures to all employees and agents by disseminating written materials that explain what is required with respect to compliance. My company has a strong system for training new and existing employees in regulatory requirements. My company's training programs include training for both corporate and business units. My company's compliance and ethics training goes beyond narrow specialized compliance topics. My company's compliance training for its employees is meaningful. My company needs to do a better job with respect to training. My company provides ethics training to all of its employees. My company needs to do a better job with respect to ethics training. My company has trained employees on the promotional communications that they can and cannot make with respect to my company's products. Attendance at all compliance training programs is mandatory. My company is effective at integrating new hires and promotions into its compliance program. Compliance training is given as part of initial orientation. My company gives reminder training sessions at regular intervals to notify employees of changes in standards or procedures, to review the program, and to provide an opportunity for employees to raise questions. My company keeps its employees current on new regulatory developments. My company has prepared a compliance manual that outlines applicable legal requirements and established standards and procedures for compliance, including reporting mechanisms. My company's compliance manual is distributed to all employees. My company's compliance manual serves as a primary resource at training sessions. My company's compliance program is tailored to the different legal requirements applicable to, and the different skill levels of, employees in different departments. My company verifies effective dissemination of compliance program information (e.g., ending training programs with a test to assess employee understanding). My company has achieved a high level of awareness about the need for compliance among its employees. My company employs outside consultants to set up and review compliance training materials and systems. Compliance objectives are incorporated into each employee's review. Compliance is an express goal for every employee's employment objectives. My company has taken sufficient steps to achieve compliance through adequate monitoring, auditing, and reporting systems (The Guidelines require that the organization must have taken reasonable steps to achieve compliance with its standards, for example, by using monitoring and auditing systems reasonably designed to detect criminal conduct by its employees and other agents and by having in place and publicizing a reporting system for employees and other agents to report criminal conduct within the organization without fear of retribution. In addition to these practices, other companies have recognized the importance of other monitoring systems, for example, monitoring and benchmarking their competitors' compliance). My company's monitoring, auditing and reporting systems are tailored to conduct thought to be detected. My company's monitoring and auditing systems are tailored to the persons who, by virtue of their duties, have the greatest opportunity to violate the law. My company conducts regularly scheduled and ad hoc internal reviews to assess compliance. My company uses corporate auditing or corporate compliance teams. My company regularly audits its clinical trials. In addition to in-house auditors, my company uses outside consultants to measure compliance. In my company, auditors are always independent of the personnel they are reviewing. In my company, auditors have direct access to the designated compliance coordinator. My company tracks audit findings. My company uses metrics to assess risk and impact areas. As part of its compliance monitoring, my company looks for repeat compliance violations. My company benchmarks its compliance against other similar companies. My company benchmarks its compliance against GBP norms. My company has a mechanism by which employees can comfortably and with confidence report on compliance without fear of reprisal. In my company, reporting systems ensure the anonymity of employees who report a compliance issue. My company provides access to an Ombudsman or toll free hotline for employees to anonymously report compliance or ethics concerns. All employees in my company are aware of available reporting systems. My company supports and encourages employees who report or correct compliance problems. Employees at my company are hesitant to discuss compliance issues with management. The reporting structure ensures that people with quality or compliance responsibility have independent reporting such that they are not subject to pressures of manufacturing output. Compliance standards are consistently enforced through appropriate disciplinary mechanisms, including appropriate discipline of employees responsible for the failure to detect an offense (Pursuant to the Federal Sentencing Guidelines, compliance standards must be consistently enforced through appropriate disciplinary mechanisms, including, as appropriate, discipline of individuals responsible for the failure to detect an offense. However, the appropriate form of discipline should be case specific. Not only is this principle important for employees who actually administer compliance policies and procedures, corporate and business unit leaders should also be held accountable for their actions). Disciplinary action is consistently enforced toward those who have a responsibility to oversee and implement the compliance program, as well as those who commit an offense. My company consistently enforces its Code of Conduct with every employee and imposes appropriate sanctions where necessary. Corporate and business unit leaders in my company are accountable for compliance violations. Discipline is proportional to the offense, reflects the impact of the offense on the company, and considers other individual circumstances. After a compliance offense has been detected, all reasonable steps are taken to respond appropriately (The Guidelines provide that for an effective compliance program, after an offense has been detected, the organization must take all reasonable steps to respond appropriately to the offense and to prevent further similar offenses. This response should include any necessary modifications to its program to prevent and detect violations of law). My company always investigates allegations of misconduct. My company reacts quickly to resolve compliance problems. When resolving compliance issues, my company addresses the problem's source. Decisions about compliance at my company (e.g., recalls) are unbiased. After an offense has been detected, a sufficiently aggressive review of the compliance program and training systems are undertaken. After an offense has been detected, a review of the effectiveness of the compliance coordinator is undertaken. My company makes recall decisions with adequate input from all relevant disciplines within the company. My company has a well-developed plan for recalling large quantities of product, should that be necessary. A thorough compliance assessment is done as a part of due diligence for every acquisition (Although not specifically addressed by the Federal Sentencing Guidelines, an organization should be sure to perform due diligence on every company prior to an acquisition. Moreover, once the organization acquires a company, it should work to integrate that company into the fabric of the organization's compliance program. These two steps are indispensable in ensuring that a newly-acquired company does not result in enforcement actions against the acquiring organization). My company looks at a company's regulatory submissions as a part of due diligence. Once an acquisition is complete, my company moves quickly to integrate the newly acquired company from the compliance perspective. My company has enough staff to respond effectively to compliance issues (Clearly, a company's GBP department must have the resources to do its job effectively. Additionally, many companies recognize that one of the resources that helps them to achieve a high level of compliance are web-based programs for reporting and training. Although perhaps not necessary in a small company, in larger companies web-based compliance programs help to achieve consistency among corporate and business units and also help to ensure that compliance issues that develop across a company are detected as soon as possible). My company should invest more resources in compliance initiatives. The regulatory function generally has the necessary financial and human resources to perform its function well. My company does a good job of using technology to help manage compliance, particularly with respect to web-based reporting for complaint handling and vigilance. My company uses web-based employee training programs. My company uses subject matter experts to help with difficult compliance issues. My company organizes implementation teams for significant changes in regulatory requirements. There is generally good internal communication and coordination among compliance personnel (In addition to communicating standards and procedures to employees, it is also important for the corporate and business units within a company to maintain frequent communication about compliance). Communication is well organized such that compliance best practices in one group (e.g., a business or corporate unit) are shared with other groups throughout the company. Communication between and among corporate and business units is such that a unified compliance policy is maintained for all units. Corporate units receive regular compliance reports. Business units share regular compliance reports. The Board of Directors receives a compliance update at least annually. My company has an adequate program in place to stay abreast of new regulatory developments. My company identifies new regulatory requirements early, assesses their impact, and integrates them quickly into the fabric of the company. In my company there is good alignment between compliance objectives and compensation incentives (Although the Federal Sentencing Guidelines contemplate that compliance standards will be enforced through appropriate disciplinary measures, they do not mandate that a company reward its employees for achieving a high level of compliance. Nonetheless, many companies have recognized the importance of this practice in achieving their compliance goals). My company's bonus plans incorporate compliance metrics. My company participates in trade associations (Clearly, it is possible for a company to achieve a high level of compliance without participation in trade associations. However, many companies have recognized the value of this type of industry interaction in the pursuant of compliance. A trade association permits interaction among companies that may not occur otherwise, and therefore facilitates the exchange of tactics and practices for compliance. Additionally, often trade associations allow companies, especially small companies, to interact with regulatory agencies in a way that would not otherwise be possible).

“Aggravating Circumstances”. (These questions within the written questionnaire, which will be answered “yes” or “no” and will not be evaluated on a seven-point scale—reflect those factors that may greatly affect a compliance level of compliance and associated risk of an enforcement action.) My company's compliance violations are gross, flagrant, or intentional. My company has falsified data. My company has tried to cover up or hide its noncompliance from regulatory agencies (The Federal Sentencing Guidelines provide that an organization's culpability for an offense can be increased if the organization obstructed justice in any way). My company's noncompliance has been continuous or repetitive. My company's noncompliance concerns one of its principal products (If the noncompliance impacts a major product, this increases the visibility and the magnitude of the violation).

The written questionnaire may end with several background questions, such as an inquiry into the best description of the department the individual works in (for example, either clerical, technical, managerial, research & development, or other). Also, the length of service with the company and the individual's satisfaction with the company may be determined. Finally, other comments may be provided that potentially affect the general scoring of the written questionnaire (individuals with motives to bolster or discredit a company may be discounted by an appropriate factor).

Second, after the written questionnaire, responders may be orally interviewed, without directly attributing statements from the responders in the reports given to the company's management. The reason for having oral interviews is to drill down deeper into compliance issues raised in the written surveys. In some cases, compliance personnel may not be candid. On the one hand, they may overstate compliance concerns to draw management's attention to the compliance function and get more resources for compliance. At the other extreme, they may be fearful of too much attention to the compliance function and understate their concerns. The oral interviews, in either case, are designed to more objectively assess the degree of compliance.

The oral survey will be accompanied by both written instructions to the interviewer, as well as sample questions. The instructions will explain that the purpose of the index's oral survey is two-fold. First, it gives the consultant administering the index an opportunity to drill down more deeply into issues that the written questionnaire raised. In this regard, not only does the oral survey provide an opportunity to gain more information about areas of noncompliance indicated by the responder, but it also provides a chance to clarify inconsistencies and confusions that the written questionnaire brought to light. The instructions may also explain that an interviewer should further explore an area on the written questionnaire in the following circumstances: The interviewee has written comments beside a question in the written questionnaire. The interviewee indicated a strong degree of noncompliance. The interviewee's answers are inconsistent with each other or with others in the company.

Second, the oral survey instructions may explain that the oral survey provides an opportunity to ask more open-ended questions about the company's compliance status, best practices, company culture, and relationship with the regulatory organization. Additionally, the oral survey will provide suggested questions and an interview format for the interviewer, but may explain to the interviewer that he or she should not feel constrained to follow the format of the questions. The following are examples of questions for an oral survey for the device operations of a regulated company:

Background Questions What is your title? How long have you been in that position? (If short time, what was prior position, how long there?) What are your specific duties within the company? How would you describe your role with respect to compliance? How does your company organize the regulatory functions at your company? The quality function?

Compliance Questions Describe your company's compliance status. Describe how your company solves compliance problems. Describe how your company's compliance status has evolved over the past five years. Describe your company's greatest compliance challenges? (Follow up question: What does your company plan to do about those challenges and when?) Describe what your company needs to do to improve its compliance. (Follow up questions: Does your company have plans to make those improvements? If so, what is your timetable for making them?) Does your company have recurring compliance problems or compliance problems in discrete areas? How would you compare your company's compliance to other companies of similar size that make similar products? Do you think your compliance status is better or not as good? Why? How many regulatory and quality staff do you have at the corporate level? At the operating company level? (Follow-up question: Is the number of staff sufficient?) Do the regulatory and compliance staffs have the resources that they need to do an effective job? Describe your company's compliance program and initiatives. Are these working? Are these sufficient? What are the strengths and weaknesses of your company's compliance and quality programs? The interviewer will also be instructed to ask follow-up questions regarding compliance based upon the written questionnaire.

Best Practice Questions: Ask follow-up questions regarding best practices based upon the written questionnaire. The seven principal categories of best practices are: Compliance Standards and Procedures; Oversight Responsibility for Compliance; Delegation of Authority for Compliance Standards and Procedures; Communication of Standards and Procedures; Achieving Compliance through Auditing, Monitoring and Reporting; Enforcement of Compliance Standards and Procedures; and Response to a Compliance Offense. Additional categories include: Practices Relating to Corporate Acquisitions; Compliance Resources and Initiatives; Use of Technology to Achieve Compliance; Ongoing Compliance Communication and Updates; Company Incentives for Achieving Compliance; and Interaction with Industry.

Scoring of the company compliance interviews involves first calculating a score for the written questionnaire by calculating an average score for responders on the questions. Individuals in the general corporate category may receive a special weighting (for example, twenty-five percent (25%) of the overall average regardless of the relationship of corporate responses to total responses). The oral survey is scored by the interviewer, who will rate the interviewee's responses on a scale of 1 to 10 for the following factors: the seriousness and volume of the company's known compliance shortcomings; the company's success in adopting best compliance practices; the extent to which the company's culture promotes compliance; and the company's relationship with the regulatory organization. Each of those categories will be weighted the same as the categories of the written questionnaire. A preliminary company interview score is calculated by weighting the written questionnaire scores at, for example, about fifty percent (50%) and the oral interview scores at, for example, about fifty percent (50%) (Clearly the internal company people have the best, most detailed basis for evaluating the company. The external questioner, though, can see conditions more objectively and can more easily compare the company's achievements with industry norms). Next, the overall candor of the respondents may be evaluated. In the written instrument, candor will be tested by asking the same question different ways, and by asking different people. Moreover, in the oral interviews, the interviewer will form an opinion of the interviewee's candor. Candor is an important prerequisite to having confidence that the information is accurate. A final company compliance interview score is determined by multiplying the total preliminary score by the candor factor. This score may be converted to a quartile scale.

Biological Materials and Information.

The type of biological materials and information may also bear on the risk of accidental or intentional release or theft. Therefore, the present invention obtains information about the company's biological materials and data. The vast plethora of research, development, manufacturing, and other use of numerous biological materials presents various forms of accidental and intentional biosecurity and biosafety risks. Materials which may present biosecurity and biosafety risks include, but are not limited to: Bacillus anthracis; Bordetella pertussis; Bordetella pertussis; Brucella (B. abortus, B. canis, B. melitensis, B. suis); Burkholderia pseudomallei (Pseudomonas pseudomallei); Campylobacter (C. jejuni/C. coli, C. fetus subsp. fetus); Chlamydia psittaci, C. pneumoniae, C. trachomatis; Clostridium botulinum; Clostridium tetani; Corynebacterium diphtheriae; Escherichia coli (Cytotoxin-producing (VTEC/SLT) organisms); Francisella tularensis; Helicobacter pylori; Leptospira interrogans—all serovars; Listeria monocytogenes; Legionella pneumophila; other Legionella-like agents; Mycobacterium leprae; Mycobacterium spp. other than M. tuberculosis, M. bovis or M. leprae; Mycobacterium tuberculosis, M. bovis; Neisseria gonorrhoeae; Neisseria meningitides; Salmonella; Salmonella typhi; Shigella spp; Treponema pallidum; Vibrionic enteritis (Vibrio cholerae, V. para-haemolyticus); Yersinia pestis; Coccidioides immitis; Cryptococcus neoformans; Histoplasma capsulatum; Sporothrix schenckii; Pathogenic Members of the Genera Epidermophyton, Microsporum, and Trichophyton; Miscellaneous Molds; Blood and Tissue Protozoal Parasites of Humans; Intestinal Protozoal Parasites of Humans; Trematode Parasites of Humans (Schistosoma spp. and Fasciola spp.); Cestode Parasites of Humans—Echinococcus granulosus, Taenia solium (cysticercus cellulosae) and Hymenolepis nana; Nematode Parasites of Humans; scrapie prion; TME prion; CWD prion; BSE prion; FSE prion; EUE prion; kuru prion; CJD prion; GSS prion; FFI prion; Hendra and Hendra-like Viruses (includes virus formerly known as Equine Morbillivirus); Hepatitis A Virus, Hepatitis E Virus; Hepatitis B Virus, Hepatitis C Virus (formerly known as nonA nonB Virus), Hepatitis D Virus; Herpesvirus simiae (Cercopithecine herpesvirus [CHV-1], B-virus); Human Herpesviruses; Influenza; Lymphocytic Choriomeningitis Virus; Poliovirus; Poxviruses; Rabies Virus; Retroviruses, including Human and Simian Immunodeficiency Viruses (HIV and SIV); Transmissible Spongiform Encephalopathies (Creutzfeldt-Jakob, kuru and related agents); Vesicular Stomatitis Virus; Chikungunya; Junin; Rift Valley fever; Venezuelan Equine encephalomyelitis; Yellow Fever; Ebola; Sabia; Machupo; Lassa; RNAi; mRNA; cDNA; and Marburg. The invention may categorize the types of biological material based on various chemical, physical, and biological characteristics. For example, such characteristics may include molecular size, molecular domains, ability to survive in different environments, infectiousness, dormancy, reproduction rate, resistance to drugs, mutation rate, whether the agents may spread through the air, contact, or body fluids, mortality rate, cytotoxicity, genotoxicity, mutagenicity, stability, and other characteristics known to those skilled in the art.

Auditing may be used to determine whether: a system of accountability for select agents has been established, followed, and audited; an accounting procedure to ensure adequate control of select agents and maintain up-to-date inventory of seed stocks, toxins, and agents in long-term storage has been established; records include data regarding the agent's location, use, storage method, inventory, external transfers (sender/receiver, transfer date, and amount), internal transfer (sender/receiver, transfer date, amount), further distribution, and destruction (method, amount, date, and a point of contact); procedures have been established and followed that maintain accurate and up-to-date records of authorizations for entry into limited access areas (i.e., a current list of persons who possess door keys and those who have knowledge of keypad access numbers or the security system); procedures for bringing select agent specimens into the laboratory, facility, and/or organization have been established, followed, and audited; a centralized receiving area for select agents has been established to maximize safety and minimize security hazards associated with damaged or unknown packages; facilities established procedures for inspecting all packages (i.e., by visual or noninvasive techniques) before they are brought into the laboratory area; suspicious packages are handled as prescribed by federal and state law enforcement agencies; biologic safety cabinet or other appropriate containment device are used when opening packages containing specimens, bacterial or virus isolates, or toxins; packages are opened by trained, authorized personnel; package, label, and transport of select agents are in conformance with all applicable local, federal, and international transportation and shipping regulations, including US Department of Transportation (DOT) regulations; materials that are transported by airline carrier comply with packaging and shipping regulations set by the International Air Transport Association (IATA); personnel who package, handle, and ship these agents (including import and export) are subject to all applicable training; responsible facility officials are notified of all select agent transfers, internal or external; required permits (e.g., granted by the US Public Health Service, USDA, DOT, US Department of Commerce, and IATA) are obtained before select agents are prepared for transport; standard operating procedures are in place for import and export activities; contaminated or possibly contaminated materials are decontaminated before they leave the laboratory area; hand-carrying select agents is avoided when transferring them to other external facilities; if select agents are to be hand-carried on common carriers, all applicable packaging, transport, and training regulations are followed; protocols for intra-facility transfer of all select agents are established and followed.

A sub-score for the biological materials information may be calculated similar to the method of calculating the personnel sub-score above, wherein the results of audits and questionnaires are variously weighted for the different information.

Scoring Index—Compliance.

After the data described above are examined and sub-scores calculated, they are combined into one overall score, or “base score.” These base scores may be used for comparisons across the industry.

The index may be normalized such that an organization's base score may be evaluated based upon quartiles. More specifically, a company's base score and the index itself may be expressed in a score from zero (0) to one hundred (100), and the cutoffs of twenty-five (25), fifty (50) and seventy-five (75) are designed to be the cutoffs between the four quartiles among companies. For example, if a company received a base score of less than twenty-five (25), it would be in the lowest (i.e., least compliant) quartile. In this regard, as explained above, the index may be most analogous to grading on a curve—it reflects the relative degree of compliance among companies in these industries. However, other scoring schemes known to those skilled in the art (for example, as in the insurance, security, and regulatory auditing industries) may also be employed.

After the base score is determined, a risk factor may be developed, which may be used in a separate calculation to calculate a company's adjusted score. Unlike the elements that go into the base score, the risk factor may simply reflect unique circumstances regarding an individual company that affects the risk of noncompliance but that are not a basis for comparing the company to its peers. Although the index collects data on these for an individual company's assessment, this data may not necessarily be entered into the database and may not necessarily be shared with other companies.

The base score may be multiplied by the risk factor to reach a company's adjusted score. The risk factor may be calculated as follows: Company at average level of risk (for example, 1); Company at greatest risk (for example 0.7, except companies may go lower if there has been a major civil or criminal penalty against the company); Company at least risk (for example 1.3).

This Risk Factor parameter may initially be calculated by examining the most significant risk factor, which may include, but not be limited to: theft of biological material or information; inadvertent or intentional release of biological materials; destruction of facilities; and/or civil and criminal penalties and other enforcement actions against the company.

The risk factor may be decreased (i.e., the company is facing more risk) based on other factors such as business concerns. Other business concerns that may decrease the risk factor include: the company facing financial difficulties (companies going through significant financial challenges are on average more likely to have employees who take compliance risks to look better. Additionally, a company may not have the resources necessary to achieve compliance); below average amount of staffing (companies that are thinly staffed are at a higher risk for an enforcement action because there are fewer checks and balances. Additionally, employees are more likely to feel the need to cut corners); high rate of acquisitions (small companies often have compliance problems as they prepare their businesses for sale, and companies that purchase them often inherit those problems); products use high risk to health technology; significant new technology areas for the company (companies that venture into new areas typically face a steep learning curve, and that learning curve carries greater risk in the interim); unusually wide breadth of products (broad product portfolios will often mean that a company's compliance resources are stretched too thinly, which leads to greater risk of an enforcement action); and company size (being a large company increases the risk of an enforcement action for two reasons.

The risk factor may be increased (i.e., the company is facing less risk) if the following are present: the company is very profitable (companies that are very profitable may have more resources to invest in achieving a high level of compliance); and Products and research employ low risk to technology. Also, companies that take the time and expense to achieve certification to standards are typically more likely to be in compliance with GBP requirements. However, this factor can also have the opposite effect. That is, companies may focus so intently on achieving international or other standards that they neglect regulatory, security, and safety requirements. Thus, this factor may be carefully examined for each company.

Furthermore, the index may be developed over time from companies that participate in the index program. The data resulting from index, when sanitized to remove the company's identity, may go into the database that allows for meaningful comparisons. Over time, as more and more companies participate, that database may become more and more robust, and the comparisons will become more meaningful.

To facilitate companies to utilize the index, and to increase the robustness of the database and index, a program to certify individuals and organizations in the use of the index may help to increase the quality of data. While the index seeks to base the assessment on objective data, there may also be a component related to the judgment and skill of the administering auditors. The selected auditors may be required to participate in a training program in which they will learn the nuances of the index calculation and seek to achieve greater standardization of the assessments.

After a certified auditor completes an assessment leading to an index calculation, the consultant may provide the sanitized data coming out of the assessment to a database, thus providing the consultants with an up-to-date analysis of the industry comparisons.

Management and Underwriting of Biosecurity and Biosafety Risks.

The compliance/risk index described above may be used to predict and assess the probability and degree of harm from biosafety and biosecurity incidents, including but not limited to incidental and/or intentional release of biological materials and/or information. Such predictions and assessments may be used to establish insurance premiums, identify and monitor activities to mitigate such risks and potential harm, and identify training and certification needs. The accreditation and certification methods and systems described above may be used alone and/or in conjunction with insurance premiums and other remedial and preventative actions (such as, for example, implementing the various policies, procedures, safeguards, etc. described in the various auditing and scoring systems described above) to mitigate biosafety and biosecurity risks and harms.

In various exemplary embodiments of the systems and methods according to this invention, the organizational task is to establish reasonable insurance premiums for insuring against damage caused by contingent harmful incidents, such as inadvertent or intentional release or theft of biological materials. In various exemplary embodiments, the analysis is performed to determine a risk factor R associated with an entity that is to be insured. In various exemplary embodiments, the risk factor R is a function of a threat factor T to the entity, a vulnerability factor V of the entity to the threat, and a consequence factor C if an incident occurs. This relationship can be expressed mathematically as:

R=f(T,V,C). (1)

In various exemplary embodiments, the risk relationship expressed in Eq. (1) is assumed to be axiomatic.

In various exemplary embodiments, analyzing or assessing the risk includes determining the factors, or random variables, that influence the level or likelihood, which is itself a random variable of the threat of release of biological materials from the entity or other related incident and the vulnerabilities of the entity and surroundings to damage, that is, the likely damage level, which again is itself a random variable by various release mechanisms. In various exemplary embodiments, the entity is a building, laboratory, farm, plant, university, or other company or entity.

In various exemplary embodiments, analyzing or assessing the risk includes one or more of forming a generic hierarchy of variables (corresponding to the risk and compliance index) that have been defined to influence the likelihood of biosafety and biosecurity incidents and likely damage levels; defining the states that can be taken by random variables; defining the conditional linkages or influences among the various variables; forming one or more hypotheses concerning the level of influence the random variables have on each other, including the likelihood of release, theft, and/or other biosafety and biosecurity incidents and the likely damage levels; creating a model that accurately reflects the risk to the entity/environment/society based on the likelihood of incidents, the likely damage levels, and the replacement cost of the entity and collateral damage; validating and evaluating model risk quantification results; and collecting any desired or necessary additional data that can be used to implement changes in the defined set of the random variables, their states, and their conditional linkages.

In various exemplary embodiments, the risk factor R is expressed as a gross expected loss. Similarly, the threat factor T is expressed as a probability of incident. In contrast, the vulnerability factor V is expressed as a damage factor, which is the percent damage to an entity/company/environment. The consequence factor C is expressed as a cost of replacement, cleaning, injury, collateral damage etc. In various exemplary embodiments, the variables that influence the probability of incident are determined by a domain expert or a set of one or more domain experts. In various other exemplary embodiments, the variables that influence the probability of incidents are determined using an expert system. The set of one or more domain experts is familiar with what may cause biosafety and biosecurity incidents, and may rely on the scoring index described above alone and/or in conjunction with other variables. The set of more or more domain experts may also understand how different types of companies/entities will be affected by certain types of incidents. In various other exemplary embodiments, the variables that influence the probability of incidents are determined using an expert system. In such exemplary embodiments, the expert system is an automated system that includes trained data that replicates the experience and judgment of the domain experts and/or the scoring index. The trained data is updated with current information related to loss assessment, such as information on incident threats and change of characteristics of facilities, personnel, biological materials, etc.

In various exemplary embodiments, the set of one or more domain experts and/or the expert system determines if the state of an influence variable depends on the condition, or state, of some other influence variable. The set of one or more domain experts and/or the expert system determines whether one influence variable has an influence on the state of another influence variable. The set of one or more domain experts and/or the expert system evaluates the influence variables in the generic variable hierarchy and defines the conditional linkages among the influence variables.

In various exemplary embodiments, the set of one or more domain experts and/or expert system generates the one or more hypotheses based on the strength of the linkage, that is, the level of dependence or influence of the state of an influence variable upon the state of another influence variable. In various exemplary embodiments which use the set of one or more domain experts, in the absence of extensive data, the domain experts use the best information available, along with their experience and knowledge of the domain, to make subjective estimates as to what the likelihood of an incident will be. The set of one or more domain experts and/or the expert system develops subjective probability tables that define how the state of one influence variable influences the state of another influence variable.

In various exemplary embodiments of the systems and methods of this invention, Bayesian conditional probability theory is used to express the conditional likelihood of a set of multiple variables. In various exemplary embodiments, probability tables are created to associate the conditional dependencies among the influence variables and to propagate the dependencies through a conditional linkage diagram.

In various exemplary embodiments, standard software packages can be used to enable the set of one or more domain experts and/or the expert system to create a conditional linkages diagram, commonly known as an influence diagram. The standard software packages then use the influence diagram to create template probability tables that the set of one or more domain experts and/or the expert system can complete to define the conditional probability relationships among the influence variables. When the probability distributions are complete, the influence diagram becomes a Bayesian network that is capable of propagating belief levels. In various exemplary embodiments of the systems and methods of this invention, the Hugin® software package is used to create the conditional linkage diagrams.

In various exemplary embodiments, using the Bayesian probability theory as implemented in the Hugin® software, the model is automatically created.

When assessing an insurance loss risk, the conditional linkages diagrams also include a gross estimated expense node, an estimated loss claim node and a building replacement/collateral damage cleanup cost node. In various exemplary embodiments, the gross estimated expense node indicates a risk assessment associated with insurance premium calculations. The estimated loss claim node indicates a damage level, such as a percentage of the value of the company/surroundings. The building cost node indicates a total value of the company and/or surroundings.

In various exemplary embodiments, where the risk to be assessed is, for example, insurance loss risk, each insured entity is awarded a damage rating or damage factor, which is a number representing an estimated percentage of loss that the entity would experience given that the entity is subjected to a biosafety/biosecurity incident. This is represented by:

Damage Factor=Estimated Loss Claim/(Remediation+Injury Cost). (2)

In various exemplary embodiments, the damage factors are determined for each type of threats as a percentage of loss.

In various exemplary embodiments, the direct gross expected loss (GD) of an entity from an incident is determined to be the product of the probability of occurrence, P(O), of an incident, and the estimated loss claim.

In various exemplary embodiments, the direct gross expected loss GD can be expressed as:

GD=P(O)×LE(3) where:

P(O) is the probability of an incident at a company;

and

LE is the expected loss claim.

In various exemplary embodiments, the set of one or more domain experts and/or an expert system analyze different representative incidents relating to various facilities, personnel, and biological materials. The results of the analysis, with some adaptation and refinement, are applied to an incident at the company whose risk is being assessed. The descriptions of these incidents provide users the information they need for an accurate risk assessment.

In various exemplary embodiments, each of the incidents designed by the set of one or more domain experts and/or the expert system is not considered equally likely to occur. Estimates of the incident probabilities are determined based upon the knowledge of the set of one or more domain experts and/or the expert system (including the compliance/risk index score described above).

In various exemplary embodiments, the collateral risk or collateral damage to a property due to an incident within a radius of the property whose risk is to be assessed can be determined. For a major urban area, such as Manhattan, the likelihood of collateral risk or collateral damage to an entity is a factor that may be significant in assessing risks and/or determining the insurance premium.

As shown in FIG. 7, the risk assessment system, in various exemplary embodiments, is implemented on a programmable general-purpose computer. However, the system can also be implemented on a special-purpose computer, a programmed microprocessor or micro-controller and peripheral integrated circuit elements, and ASAIC or other integrated circuits, a digital signal processor (DSP), a hardwired electronic or logic circuit, such as a discrete element circuit, a programmable logic device such as a PLD, PLA, FPGA or PAL, or the like. In general, any device capable of implementing a finite state machine that is in turn capable of implementing the flowchart shown in FIG. 1 can be used to implement the risk assessment system.

The input/output interface interacts with the outside of the risk assessment system. In various exemplary embodiments, the input/output interface may receive input from one or more input devices connected with the input/output interface via one or more links. The input/output interface may display analysis result at one or more display devices connected to the input/out interface via one or more links. The one or more display devices may be a display screen, an interactive screen or the like. The one or more input devices may be a mouse, a track ball, a keyboard, voice recognition system, a joy stick or the like. The one or more input devices may also be switches or other widgets displayed on the one or more display devices.

The memory may include an expert data portion and an analysis result portion. The expert data portion stores expert data including information about companies that might experience a biosafety/biosecurity incident. The analysis result portion stores analyzed results based on user input and the expert data.

The memory can be implemented using any appropriate combination of alterable, volatile, or non-volatile memory or non-alterable or fixed memory. The alterable memory, whether volatile or non-volatile, can be implemented using any one or more of static or dynamic RAM, a floppy disk and disk drive, a writeable or re-writeable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or a DVD-ROM disk and disk drive or the like.

In an exemplary embodiment of the risk assessment system, the display generating circuit, routine or application generates graphical user interface elements that display the analysis results to users. The influence determining circuit, routine or application determines the influence among the risk and/or property variables. The hierarchy formulating circuit, routine or application formulates the structure in which the impact of one variable propagates through the nodes of other variables in the structure.

The state defining circuit, routine or application may define the states of the variables. The linkage defining circuit, routine or application defines how the variables are interconnected and how they respond to each other. The hypothesis generating circuit, routine or application may generate hypothesis regarding, for example, a threat, such as a chemical dispersion model.

The model initializing circuit, routine or application initializes a prediction model and/or simulation regarding the results of an incident. The model creating circuit, routine or application allows a user to update and/or generate a prediction model and/or simulation regarding the results of an incident based on, for example, information uniquely acquired by the user. The analyzing circuit, routine or application analyzes to create analysis results, such as, for example, risk assessment and/or insurance risk loss, based on user input and the expert data.

In operation of the exemplary embodiment of the risk assessment system, the input/output interface, under control of the controller, receives inputs from the one or more input devices regarding risk assessment data and/or insurance risk loss data of a company, and either stores them in the memory and/or provide them directly to the influence determining circuit, routine or application.

The influence determining circuit, routine or application, based on the received inputs, determines the threat and/or company variables necessary to assess the risk of the company and the influence among the threat and/or company variables, using the expert data stored in the expert data portion of the memory. The influence determining circuit, routine or application, under control of the controller, outputs the determined variables and the influence either to the memory or directly to the hierarchy formulating circuit, routine or application.

The hierarchy formulating circuit, routine or application, under control of the controller, inputs the determined variables and the influence either from the memory or from the influence determining circuit, routine or application. The hierarchy formulating circuit, routine or application formulates, based on the expert data stored in the expert data portion of the memory, the flow and/or direction in which an impact of one variable influences certain other variables that are located in the downstream in the hierarchy structure. The hierarchy formulating circuit, routine or application, under control of the controller, outputs the formulated flow/direction of impact either to the memory or directly to the state defining circuit, routine or application.

The state defining circuit, routine or application, under control of the controller, inputs the formulated flow/direction of impact either from the memory or from the hierarchy formulating circuit, routine or application. The state defining circuit, routine or application defines the states of the determined variables, using the expert data stored in the expert data portion of the memory. The state defining circuit, routine or application, under control of the controller, outputs the defined the states of the determined variables either to the memory or directly to the linkage defining circuit, routine or application.

The linkage defining circuit, routine or application, under control of the controller, inputs the defined states either from the memory or from the state defining circuit, routine or application. The linkage defining circuit, routine or application, based on the defined states and the expert data stored in the expert data portion of the memory, defines how different aspects or sub-tasks are linked and/or integrated into a task, and how these aspects or sub-tasks are interconnected and how they respond to each other. The linkage defining circuit, routine or application, under control of the controller, outputs the defined linkage between the aspects either to the memory or directly to the hypothesis generating circuit, routine or application.

The hypothesis generating circuit, routine or application, under control of the controller, inputs the linkage between the aspects either from the memory or from the linkage defining circuit, routine or application. The hypothesis generating circuit, routine or application generates hypotheses regarding a threat, such as, for example, a chemical dispersion model, based on the linkage and the expert data stored in the expert data portion of the memory. The hypothesis generating circuit, routine or application, under control of the controller, outputs the generated hypotheses either to the memory or directly to the model initializing circuit, routine or application. The model initializing circuit, routine or application, under control of the controller, inputs the generated hypotheses either from the memory or from the hypothesis generating circuit, routine or application. The model initializing circuit, routine or application initializes a prediction model and/or simulation regarding the results of an incident, based on the generated hypotheses and the expert data stored in the expert data portion of the memory. The model initializing circuit, routine or application, under control of the controller, outputs the initialized model/simulation either to the memory or directly to the display generating circuit, routine or application.

The input/output interface, under control of the controller, displays the initialized model/simulation from the display generating circuit, routine or application at the one or more display devices, and allows a user to update the model/simulation by inputting additional information, such as, for example, information outside the hypotheses and/or information uniquely acquired by the user. The input/output interface, under control of the controller, either stores the additional information in the memory or provides them directly to the model creating circuit, routine or application.

The model creating circuit, routine or application, under control of the controller, inputs the additional information and updates the prediction model and/or simulation, using the expert data stored in the expert data portion of the memory. The model creating circuit, routine or application, under control of the controller, outputs the updated prediction model and/or simulation either to the memory or directly to the analyzing circuit, routine or application for analysis.

The analyzing circuit, routine or application, under control of the controller, executes the updated prediction model and/or simulation, generates analysis results based on the expert data stored in the expert portion of the memory. The analyzing circuit, routine or application, under control of the controller, outputs the generated analysis results either to the memory or directly to the display generating circuit, routine or application. The input/output interface, under control of the controller, displays the analysis results at the one or more display devices.

The preceding detailed descriptions may be implemented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art. An algorithm is here, and generally, conceived to be a self-consistent sequence of steps leading to a desired result. These steps are those requiring physical manipulations of physical quantities. At some times, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, information, or the like. It should be borne in mind, however, that all of these and similar terms are to be associated with the appropriate physical quantities and are merely used here as convenient labels applied to these quantities. The algorithm itself, while capable of being implemented in a computer or other device, represents a business method capable of performance without such a physical device.

Further, the manipulations performed are often referred to in terms, such as comparing or adding, commonly associated with mental operations performed by a human operator. No such capability of a human operator is necessary, or necessarily desirable in every case, in any of the operations described herein which form part of the present invention; the operations may be organizational or machine operations. Useful machines for performing the operations of the present invention include general purpose digital computers or other similar devices. In all cases the distinction between the method operations in operating a computer and the method of computation itself should be recognized. The present invention relates to a method and apparatus for operating a business method, and may or may not include computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The previous description of the disclosed embodiments is provided to enable any person skilled in the art to make or use the biosafety and biosecurity methods and systems. Various modifications to these embodiments will be readily apparent to those skilled in the art, and the generic principles defined herein may be applied to other embodiments without departing from the spirit or scope of the methods and systems. Thus, the methods and systems are not intended to be limited to the embodiments shown herein but are to be accorded the widest scope consistent with the principles and novel features disclosed herein.

1. A method for assessing a risk of a harmful release of biological material by an entity, comprising:
(a) obtaining information about the entity's operations;
(b) obtaining information about the entity's biological materials; and
(c) combining the operations information and biological material information and scoring that information to assess the risk of harmful release of the biological material by the entity.

2. The method of claim 1, wherein the obtaining information about the entity's operations comprises obtaining audit information relating to the entity's biosecurity practices and personnel.

3. The method of claim 1, wherein the obtaining information about the entity's operations comprises obtaining audit information relating to the entity's facilities.

4. The method of claim 1, wherein the obtaining information about the entity's operations comprises obtaining audit information relating to the entity's prior accreditations.

5. The method of claim 1, further comprising determining whether the entity complies with accreditation guidelines.

6. The method of claim 5, further comprising providing biosecurity accreditation for the entity based upon the assessed risk.

7. The method of claim 5, wherein the accreditation comprises auditing the entity and providing biosecurity training for the entity's personnel.

8. The method of claim 1, further comprising altering the entity's operations, based upon assessed risk, to mitigate the risk of harmful release of the biological material by the entity.

9. A method for establishing an insurance premium usable to insure against a risk of a harmful release of biological material by an entity, comprising:
(a) obtaining information about the entity's operations;
(b) obtaining information about the entity's biological materials;
(c) combining the operations information and biological material information and scoring that information to assess the risk of harmful release of the biological material by the entity; and
(d) establishing the insurance premium for the property based on the assessed risk.

10. The method of claim 9, wherein the obtaining information about the entity's operations comprises obtaining audit information relating to the company's biosecurity practices and personnel.

11. A device for assessing a risk of a harmful release of biological material by an entity, comprising:
a memory; and
a processor connected to the memory;
wherein the processor is configured to perform the steps of:
(a) obtaining information about the entity's operations;
(b) obtaining information about the entity's biological materials; and
(c) combining the operations information and biological material information and scoring that information to assess the risk of harmful release of the biological material by the entity.

12. The device of claim 11, wherein the obtaining information about the entity's operations comprises obtaining audit information relating to the entity's biosecurity practices and personnel.

13. The device of claim 11, wherein the obtaining information about the entity's operations comprises obtaining audit information relating to the entity's facilities.

14. The device of claim 11, wherein the obtaining information about the entity's operations comprises obtaining audit information relating to the entity's prior accreditations.
